(19) United States
(12) Patent Application Publication
(10) Pub. No.: US 2006/0158437 A1
(43) Pub. Date: Jul. 20, 2006

(54) Display device

(76) Inventors: Michael M. Blythe, Albany, OR (US); Daniel T. Pinard, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/041,754

(22) Filed: Jan. 20, 2005

(51) Int. Cl. G09G 5/00

(52) U.S. Cl. 345/173

(57) ABSTRACT

Devices, systems, and methods for directing a beam of light into a display such that the beam of light undergoes internal reflection within the display and capturing a reflected light beam are disclosed.

One type of I/O component that may be used with a computing device is a touch screen. Some touch screen configurations can degrade the quality of an image projected onto the surface of the display. Moreover, many touch screens allow a user to interact with a computing device one touch at a time. In addition, touch screens can often stop working after a number of contacts with the screen have been made.

### BRIEF DESCRIPTION OF THE DRAWINGS

FIG. 1A illustrates an embodiment of a display system.

FIG. 1B illustrates an example of the interaction of the embodiment shown in FIG. 1A with an object.

FIG. 2A illustrates an embodiment of a display device having two displays.

FIG. 2B illustrates another embodiment of a display device, having two displays, interacting with an object.

FIG. 3 illustrates a block diagram of an embodiment of a display system.

FIG. 4A illustrates an embodiment of a display device having a rear angled surface.

FIG. 4B illustrates another embodiment of a display device having a rear angled surface.

FIG. 4C illustrates another embodiment of a display device, having a rear angled surface, interacting with an object.

FIG. 5 illustrates an embodiment of a display device, having two displays with one of which having a rear angled surface, interacting with an object.

FIG. 6A illustrates an embodiment of a display device having a bend.

FIG. 6B illustrates an embodiment of a display device having two bends.

### DETAILED DESCRIPTION

Embodiments disclosed herein provide methods, systems, and devices that provide an interactive display surface. Such embodiments can be useful, for example, for identifying a location of an object that is contacting a surface of a display. Embodiments of the present disclosure include device embodiments having a number of displays, cameras, and/or light sources, among others.

A light source, such as a projector, can be used to direct a beam of light into a display. In some embodiments, the light beam that is directed into the display can include one or more images to be displayed through a surface of the display.

The interactive functionality of a display can be accomplished through use of a number of sensors. In some embodiments, the number of sensors can include one or more cameras. A camera can be used to capture one or more images formed by light directed into a display and/or light reflected out of a display.

As used herein, a directed light beam can include light that is visible and/or invisible to the unaided eye which is directed into a display by a light source. A reflected light beam is light that is visible and/or invisible to the unaided eye that originates from directed light, as defined above, but is created by the directed light interacting with an object. The interaction with the object disrupts the path of the directed light.

Examples of directed light can include, light that reflects internally within the display without attaining an angle of incidence less than the critical angle and/or reflects internally within the display to attain an angle of incidence less than the critical angle to form an image on the surface of the display. Reflected light can include one or more images reflected from a display. In some embodiments, the reflected light can be a portion of the directed light containing the one or more images to be displayed through a display surface.

System embodiments may also include devices having an image comparator. In system embodiments that include the image comparator, the image comparator can compare one or more images of a directed light beam with the one or more images of a reflected light beam to determine a difference between the directed light beam and the reflected light beam. In some embodiments, the difference between the directed light and the reflected light can include a position of one or more objects contacting a surface of the display. And, in other embodiments, the difference between the directed light and the reflected light can indicate an interaction between an object and a display device. In such embodiments, an object can be a user interacting with one or more images on the surface of the display. For example, such embodiments can be used as a touch screen to interact with an individual using the display. In such embodiments, the interaction can include identifying a location of the interaction on a surface of the display.

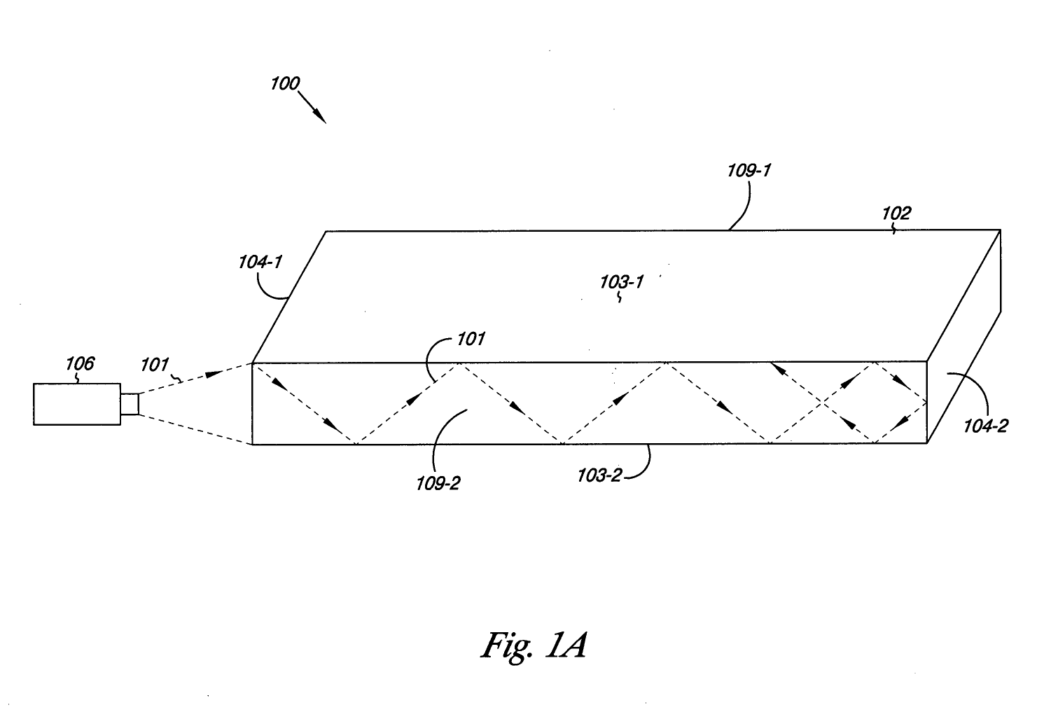

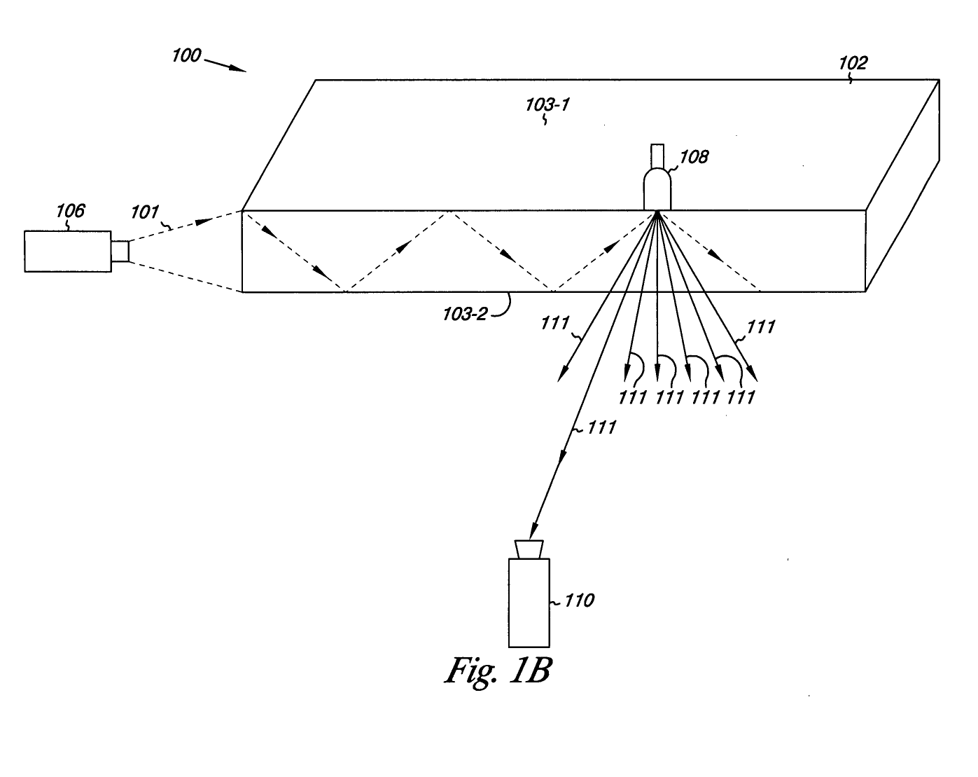

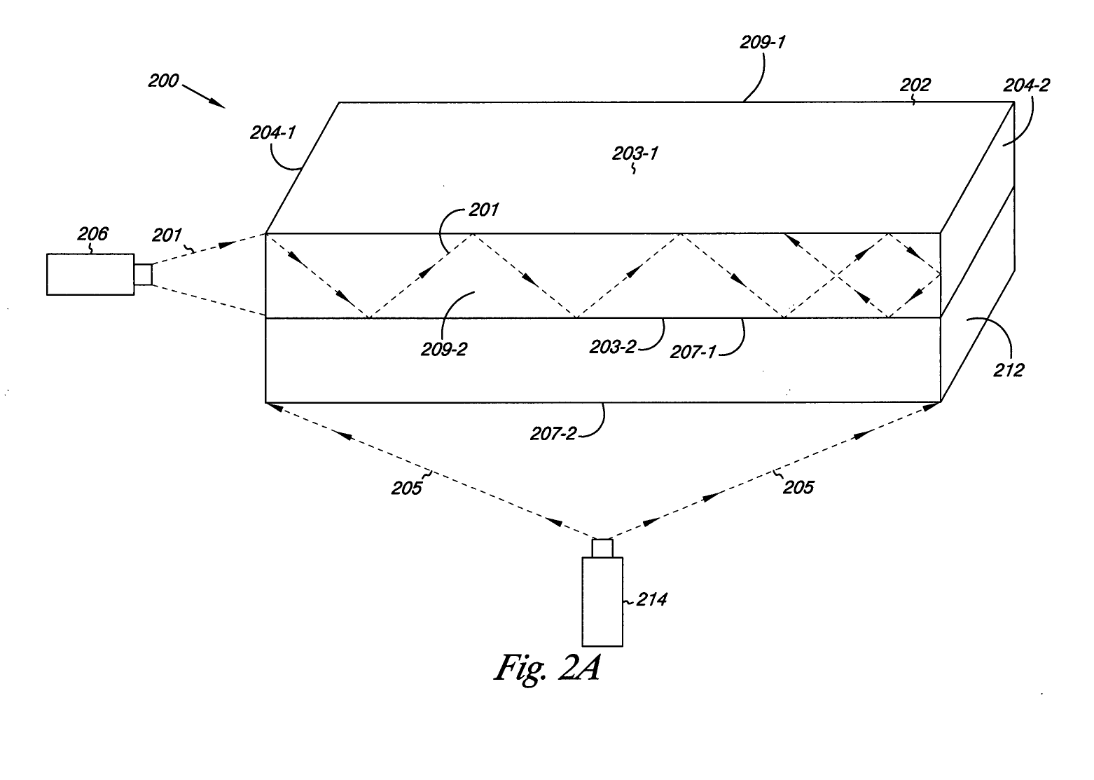

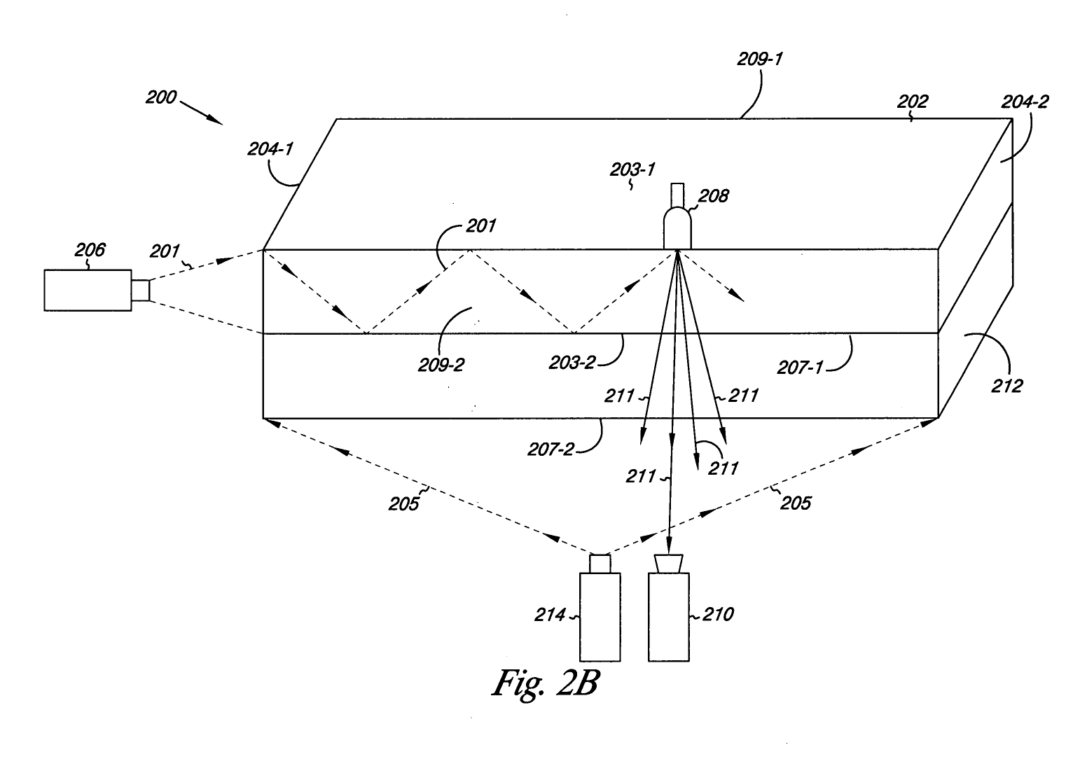

The figures herein follow a numbering convention in which the first digit or digits correspond to the drawing figure number and the remaining digits identify an element in the drawing. Similar elements between different figures may be identified by the use of similar digits. For example, 102 may reference element “102” in FIG. 1A, and a similar element may be referenced as 202 in FIG. 2A. As will be appreciated, elements shown in the various embodiments herein can be added, exchanged, and/or eliminated so as to provide a number of additional embodiments.

FIG. 1A illustrates an embodiment of a display device. In various embodiments, the display device 100 can include a display 102. In some embodiments, the display can be transparent (e.g., a viewer can see through the display) and/or semi-transparent (e.g., has a see through surface, but has an opaque opposing surface). The transparency of the display can provide additional functionality with regard to the ability for light to propagate within the display, as will be discussed more fully below. Displays can be formed from a variety of materials that include, but are not limited to, glass, plastic, a combination of glass and plastic, and other suitable materials.

Displays can include a number of surfaces, ends, and edges. For example, in the embodiment illustrated in FIG. 1A, the display 102 includes first and second surfaces 103-1 and 103-2, first and second ends 104-1 to 104-2, and first and second edges 109-1 and 109-2. In FIG. 1A, the first and second surfaces 103-1 and 103-2 extend parallel to each other and are positioned orthogonal to the ends 104-1 and 104-2, and edges 109-1 and 109-2.

In some embodiments, one or more ends, and one or more edges can include a reflective surface. For example, a reflective coating, such as a paint or film can be provided to increase internal reflection of a light beam propagating within the display. In such embodiments, the intensity of the light source directing light into the display can, in some instances, be decreased, as will be discussed more fully below.

Also shown in FIG. 1A is light source 106. Light source 106 can include any light source capable of directing a beam of light into a display. In addition, light sources can include light sources for directing a beam of light to form an image on a display surface. In various embodiments, light sources can include, but are not limited to, incandescent, halogen, infrared, light emitting diode (LED), and laser light sources, among others.

In various embodiments, a beam of light can include one or more light rays. For purposes of clarity, however, in the embodiments illustrated in FIGS. 1A-6B herein, the light rays defining an edge of a light beam or an example of a propagating light ray is illustrated. As shown in FIG. 1A, light source 106 directs a beam of light 101 into first end 104-1 of the display 102. As the light beam 101 propagates within the display 102, it can reflect off one or more surfaces, one or ends, and one or more edges. As shown in FIG. 1A, light beam 101 reflects off first and second display surfaces 103-1 and 103-2, second end 104-2, and propagates back toward the first end 104-1.

In various embodiments, the internal surfaces of the display can be designed to provide total internal reflection of a light beam 101 that is directed at the surface. As used herein, total internal reflection of a light beam is a reflection of a light beam off a surface, such as the surfaces of the first and second display surfaces, the one or more ends, and/or the one or more edges, with no emergence, or substantially no emergence of the light beam from the surface. In various embodiments, the light beam can continue propagating on its reflective path until impinging on a surface at or less than its critical angle and the light beam emerges from a surface of the display. The critical angle is the angle at which a light beam, when impinging upon a surface, will pass through the surface rather than be reflected off the surface. In the embodiments described herein, the critical angle of a light beam propagating by internal reflection within the display can be achieved by altering its angle of incidence with a surface of the display as it propagates by internal reflection within the display. In various embodiments of the present invention, the angle of incidence can be altered by contacting a surface of the display with an object, among other ways, as will be discussed below with regard to FIG. 1B.

FIG. 1B illustrates an example of the interaction of the embodiment shown in FIG. 1A with an object. As shown in FIG. 1B, light source 106 directs a beam of light 101 into display 102 of display device 100. Like FIG. 1A, the beam of light propagates within the display by internal reflection off one or more ends, edges, and display surfaces of the display.

In various embodiments, an object can interact with a display. In the embodiments of the present disclosure, an object can include one or more items, devices, components, and/or individuals that contact the display. For example, in the embodiment in FIG. 1B, the display 102 includes object 108. Object 108 is shown resting on the first surface 103-1 of display 102. In some embodiments, object 108 can include a reflective surface. Objects that include reflective surfaces can provide a higher intensity of reflection when the object contacts the display, and therefore in some embodiments, a lower intensity light source can be used with objects having a reflective surface.

The display device 100, in various embodiments, can include one or more sensors for capturing a light beam including one or more light rays directed and/or reflected into and/or out of a display. In some embodiments, a sensor can include an image capture component. For example, the image capture component can include a camera having one or more arrays of sensors. The sensors for instance, can include a camera having a number of high-resolution optical sensors having a number of Charged Coupled Devices (CCDs) for capturing directed and/or reflected light beams. In some embodiments, the image capture component can include a camera having one or more complementary metal oxide semiconductor (CMOS) sensors. The image capture component can also include a camera having a pick-up tube for capturing directed and reflected light beams.

In various embodiments, the sensor, e.g., camera, can be used for capturing one or more images within a directed light beam. In some embodiments, the camera can be used for capturing one or more images within a reflected light beam. Cameras can be used for capturing a disruption of a light beam.

For example, in the embodiment illustrated in FIG. 1B, a camera 110 is shown oriented below the display 102. In various embodiments, the camera 110 can be used for capturing a disruption of a light beam propagating by internal reflection within display 102. In various embodiments, the disruption can be due to an object contacting a surface of a display.

As shown in FIG. 1B, the disruption of the light beam 101 is due, in part, to object 108 contacting the first surface 103-1. Contacting the first surface 103-1 with object 108 can result in a disruption of the internal reflection of light beam 101 as it propagates within display 102. The disruption can cause the light beam to diverge from its reflective path and/or to scatter in a variety of directions. In some embodiments, the disrupted and/or scattered light rays can propagate within a display as a reflected light beam. In such embodiments, the reflected light beam can emerge from a display at a surface of the display such as from an end of the display. In other embodiments, the disrupted and/or scattered light rays can emerge from a display without further propagating within the display, e.g., the light rays have reached a critical angle and can emerge from a surface of the display, as discussed below.

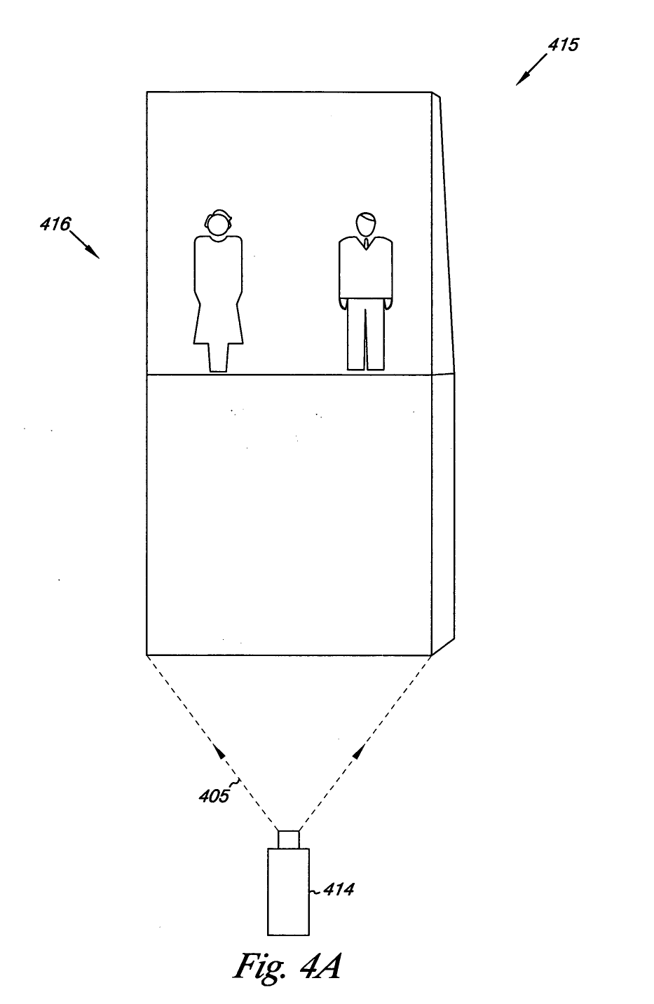

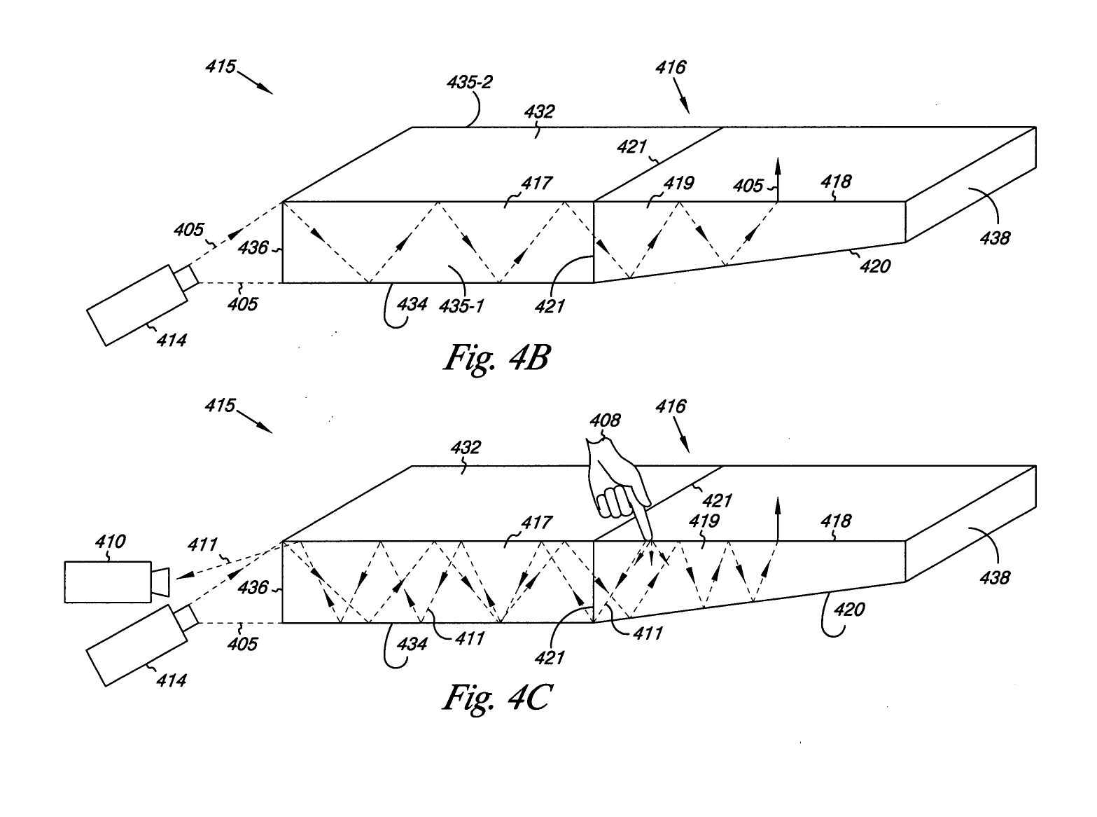

In the embodiment illustrated in FIG. 1B, the disruption and/or scattering of the light beam 101 by object 108 causes some of the light rays in the beam of light to reach at least their critical angle with respect to surface 103-2, and thereby, emerge from surface 103-2. The disrupted and/or scattered light beams 111 that emerge from surface 103-2 can be captured by camera 110 by positioning camera 110 to view at least a portion of the second surface 103-2 such that the scattered light beams 111 emerge toward camera 110, as shown in FIG. 1B. In some embodiments, the disrupted and/or scattered light beams can emerge from the display at an end of the display, as will be discussed below with respect to FIGS. 4B, 4C, 5, 6A, and 6B. As will be appreciated, the light beam propagating within the display can be disrupted by multiple objects. Thus, in various embodiments, multiple objects can contact the first surface 103-1 and can result in a disruption of the internal reflection of the light beam propagating within the display. In such embodiments, the disrupted and/or scattered light beams due to the multiple objects can emerge from the display at an end of the display and can be captured by a sensor, as will be discussed below more thoroughly.

As discussed above, the object can include a reflective surface. Objects that include reflective surfaces can provide a more intense disruption and/or scattering of the light beam. Increasing the intensity of the scattered light beam can increase the ability of the camera to detect the disruption of the light beam by an object.

In various embodiments, the disruption of the light beam can indicate a location of an object that is contacting the display. In various embodiments, the location of an object with respect to a displayed image or an image to be displayed can, for example, be determined based upon a position of the object contacting the display. In such embodiments, computer executable instructions can be used for generating x and y coordinates of a display. The x and y coordinates can be used to aid in determining the position of an object contacting the display. For example, in various embodiments, a Cartesian coordinate plane having an x and y axis can be determined based upon an area of a display that provides for internal reflection of a directed light beam, a viewable area of a display, and/or an interactive area of a display. As used herein, an interactive area of a display is any area of a display that can scatter and reflect light for reception by an image capture component, e.g., camera.

As shown in FIGS. 1A-1B, the first light source 106 directs light into the display at end 104-1 of display 102. As will be appreciated however, the first light source 106 can be positioned such that it directs a light beam into the display at any location of the display. For example, in some embodiments, the light 106 can be positioned such that it directs a beam of light toward surface 103-2. In such embodiments, the light can propagate through the display and emerge from surface 103-1 to form an image thereon.

In some embodiments, a second light source can be provided. For example, a second light source can include a light source for providing an image on a display, such as display 102 illustrated in FIGS. 1A and 1B. In such embodiments, the first light source 106 can include an infrared light source. In these embodiments, the infrared light source may not cause interference visible to a viewer with a light source providing the image on the display. In addition, in such embodiments, an infrared sensor, such as an infrared camera, can be provided such that it can capture infrared light that is reflected by object 108 contacting display 102.

FIGS. 2A and 2B illustrate another embodiment of a display device of the present disclosure. In the embodiments shown in FIGS. 2A and 2B, the display device includes two displays. In these embodiments, a first display is positioned proximal to a second display such that an image formed on the second display can be viewed through the first display. In such embodiments, by viewing the image formed on the second display through the first display, a user can view the image on the second display and/or interact with the image on the second display by contacting the first display.

As shown in FIG. 2A, the display device 200 includes a first display 202 and a second display 212. In various embodiments, the first display 202 can be positioned proximal the second display 212. Displays that are proximal to each other can be positioned such that they contact each other. Displays can also be positioned such that there is a space between the two displays. For example, as shown in FIG. 2A, the first display 202 is positioned proximal the second display 212 such that the first and second displays 202 and 212 contact each other.

In the embodiments shown in FIGS. 2A and 2B, the first display 202 can include a transparent or semi-transparent display. Images can be formed on a number of the surfaces of the various displays. For example, embodiments such as those shown in FIGS. 2A and 2B, the displays can be constructed such that an image can be formed on surface 203-1, 203-2, 207-1, or 207-2. For instance, images can be formed on the first display 202 by light beam 205 emitted from light source 214 and transmitted through the second display 212 to surface 203-1 of the first display 202. In this way, a viewer can view and/or interact with the first display 202 by contacting the first display 202 with an object, as will be discussed below.

FIG. 2A, includes a first light source 206. In the embodiment shown in FIG. 2A, the first light source 206 can be any type of light source. For example, the first light source 206 can include light source 106 illustrated in FIGS. 1A and 1B. As discussed above with respect to FIGS. 1A and 1B, the light source 206 shown in FIG. 2A can be positioned at an end of the display and can direct a light beam 201 into the end 204-1 of the display 202. In the embodiments described in FIGS. 2A and 2B, the directed light beam 201 can propagate within the first display 202 by internal reflection.

In some embodiments, the first light source 206 can include a non-visible light source, such as a light source not visible by the unaided human eye, for directing light into the first display 202. For example, since infrared light is not viewable by the unaided human eye, images transmitted through the second display 212 to the first display 202 can be less affected by such types of non-visible light.

In various embodiments, the display device 200 can also include a second light source. In the embodiment shown in FIG. 2A, the second light source includes a projector 214. In the embodiments disclosed herein, projectors can be used to form one or more images on one or more surfaces of a display.

For example, as shown in FIG. 2A, projector 214 emits light beam 205. As shown in FIG. 2A, light beam 205 is directed toward the second surface 207-2 of the second display 212. The light beam is transmitted through the display and forms an image on surface 207-1 (image not shown). As the reader will appreciate, an image formed on the surface 207-1 can be viewed by an individual on surface 203-1 of the first display 202.

FIG. 2B illustrates another embodiment of a display device. In various embodiments, the display device can include a sensor for capturing a light beam.

For example, in the embodiment shown in FIG. 2B, a sensor 210 is illustrated. The sensor 210 can, for example, include an image capture component. In various embodiments, the image capture component 210 can, for example, include a camera having a number of Charged Coupled Device (“CCD”) elements for capturing directed and reflected light beams. Embodiments can also include an image capture component with a camera having one or more complementary metal oxide semiconductor (CMOS) sensors.

In some embodiments, the image capture component can include a camera having a pick-up tube for capturing directed and reflected light beams. An infrared camera, having one or more sensors for capturing reflected infrared light as it is disrupted and scattered by an object contacting the surface, can also be used in some embodiments.

In various embodiments, the image capture component can be positioned at various locations. For example, in the embodiment shown in FIG. 2B, the image capture component 210 is positioned below the first and second displays 202 and 212.

In such embodiments, positioning the image capture component below the first and second displays can provide for the capture of a directed beam of light and/or a reflected beam of light. For example, as shown in FIG. 2B, the image capture component 210 is positioned such that it captures a displayed image on display 212 and a reflected light beam 211, originating from light source 206, and reflected toward sensor 210 by object 208. In such embodiments, capturing the image displayed and the reflected light beam 211 from the light source 206 can provide an ability to determine differences between the image displayed (e.g., directed light beam 205) and the reflected light beam 211.

Determining differences between a directed light beam, or an image that is displayed, and the reflected light beam can provide an ability to identify a location on the display in which the reflected light beam originates. In the embodiments described in the present disclosure, there are a number of ways for determining such differences, such as by comparing the reflected light beam to a directed light beam that propagates through a display by internal reflection or by comparison to a light beam used to display and image on a surface of a display.

The image can be captured with an image capture component. In FIG. 2B, a reflected light beam is captured that is caused by an object resting on a surface of the display. The differences between the directed light beam and the reflected light beam are compared to determine a location of the object resting on the display surface relative to the display surface.

As shown in FIG. 2A, for example, light source 214 emits a beam of light 205, which forms an image, e.g., an array of pixels, on display 212. As the reader will appreciate, the array of pixels forming the image can include digital data representing the array of pixels forming the image.

In FIG. 2B, the image capture component 210 captures reflected light beam 211, which is a portion of the directed light beam 205 reflected from surface 207-1 by object 208. The captured reflected light beam 211 can be converted to digital data representing the reflected light beam. The digital data representing the directed light beam 205 can be compared pixel by pixel to the array of pixel data representing the reflected light beam 211 to detect differences.

In various embodiments, tolerances can be used so that the difference, for example, falls outside a range of measurement variability. That is, the directed beam of light (e.g., beams of light 201 and/or 205, including data to be projected, data within the beam of light, or a projected image) and the reflected light beam 211 (e.g., at least a portion of directed beam of light 201 and/or 205 reflected by object 208) captured by the image capture component 210 can be compared. In this way, the location of the pixels representing the reflected light beam can be determined by correlating the pixels representing the reflected light beam to an x-y plane representing the display surface.

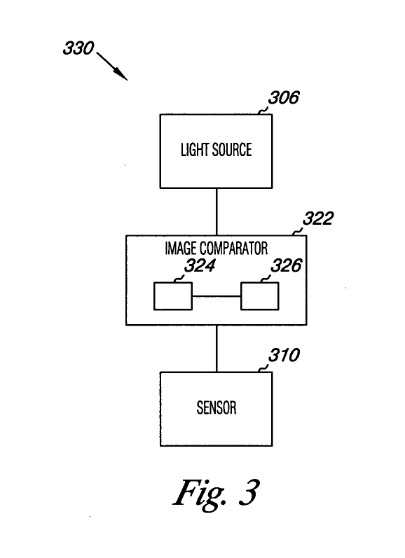

As discussed above, differences between the directed light and the reflected light can be determined in various ways, as will be discussed more fully below with respect to FIG. 3.

In some embodiments, the image capture component captures the reflected light beam 211 without capturing a substantial portion of the image displayed. In such embodiments, differences between the directed light beam and the reflected light beam can be determined by using a processor to process data representing the directed light beam with data representing the reflected light beam, as will be discussed below with respect to FIG. 3. The data representing the directed light beam can be passed upon a stream of data encoded into the directed light beam, the directed light beam itself, or the image displayed.

The display device 200 illustrated in FIG. 2B can also include object 208. As discussed above with regard to FIGS. 1A and 1B, the object can include any device, component, and/or individual. In the embodiment in FIG. 2B, the object 208 is shown as contacting the first surface 203-1 of the second display 202.

As stated above, a display can be designed such that objects contacting a surface of the display can cause light propagating within the display to be disrupted from its reflective path and to scatter. As shown in FIG. 2B, the disruption of light beam 201 is due, in part, to object 208 contacting the first surface 203-1 of the second display 202.

As described above with respect to FIG. 1B, contacting the first surface 203-1 with object 208 can result in a disruption of the internal reflection of light beam 201 as it propagates within display 202. The disruption causes the light beam to scatter in a direction opposite the object 208. And, by positioning the image capture component 210 below the first and second displays 202 and 212, at least some of the scattered light beams, i.e., reflected light beams 211 can be captured.

In some embodiments, light beams 205 from light source 214 can be reflected by object 208. These reflected light beams from light source 214 can be in addition to those reflected light beams from light source 206. In such embodiments, reflected light of the light beam 205 can be captured by the image capture component 210 or another image capture component.

In various embodiments, the two displays 202 and 212 can be formed together. In some embodiments, the display material can include a partition formed within a single piece of display material that divides the single display into two parts, rather than having to separate display units.

FIG. 3 illustrates a block diagram of a display system of the present disclosure. As shown in FIG. 3, the display system 330 includes light source 306. The light source 306 can be any light source capable of directing a beam of light, such as light source 106 illustrated in FIGS. 1A-1B, and light source 206 illustrated in FIGS. 2A-2B.

Also shown in FIG. 3 is sensor 310. As discussed above with respect to FIGS. 1A-1B, and 2A-2B, the sensor can include any sensor capable of capturing a directed light beam and/or a reflected light beam, such as a CCD, CMOS, or pick-up tube camera.

In the embodiment shown in FIG. 3A an image comparator 322 is illustrated. In various embodiments of the present disclosure, the image comparator can include a processor 324 and memory 326. In the embodiments illustrated in the present disclosure, computer executable instructions can be embodied in software, firmware, and/or circuit logic, among others, and stored in memory, such as memory 326. The processor and memory can be used with computer executable instructions for identifying a location of an object contacting one or more surfaces of a display, and/or comparing differences between a directed light beam and a reflected light beam, among other things.

In various embodiments, the location of an object contacting a surface of a display can be identified in a number of ways. For example, an image comparator can identify the location by processing data representing a disruption of a light beam by an object. In other embodiments, the image comparator can identify a location of an object contacting a display by comparing differences between a directed light beam and a reflected light beam, as will be discussed more fully below.

For example, in the embodiment illustrated in FIG. 1B, image comparator 322 can be used for identifying the location of object 108 contacting surface 103-1 of display 102 by processing data representing a disruption of a light beam by an object. In such embodiments, the location can be identified by the image comparator 322 based upon data representing the disruption of the internal reflection of the light beam 101 that has been captured by the image capture component 110. For instance, as discussed above in FIG. 1B, the disruption of propagating light beam 101 by object 108 can cause some light rays within light beam 101 to alter their angle of incidence to a level at or below the critical angle, and thus, emerge from the display. Some of the light rays, e.g., reflected light beam 111, can be captured by image capture component 110, as shown in FIG. 1B. In such embodiments, the image comparator 322 can process data representing the reflected light beam to determine a location of object 108 on the surface 103-1 of the display 102, as discussed above with respect to FIG. 1B.

In some embodiments, data representing the directed light beam can include data based upon the capture of the directed light beam through use of a sensor 310, e.g., a camera. For example, the captured directed light beam can represent image data displayed on a surface of the display.

In other embodiments, data representing the directed light beam can include data stored in memory 324 or a data stream directed to a light source for encoding as a light beam to be displayed. In such embodiments, the data stored in memory or in the data stream can represent image data to be directed to a display as a light beam. Thus, in such embodiments, sensor 310 may not be used to capture the directed light beam.

In various embodiments, a processor can be used to execute computer executable instructions for comparing differences between the directed light beam and the reflected light beam. In various embodiments, data representing the reflected light beam can include one or more reflected light beams. In such embodiments, the reflected light beam can be captured by sensor 310 and converted by processor 324 to data representing the reflected light beam. In some embodiments, the data can include image data. And in other embodiments, the data can include coordinate data, such as x and y coordinate data, as discussed above. For example, as shown in FIG. 2B, the one or more reflected light beams can provide coordinate data representing x and y coordinates of the location of object 208 contacting display 202.

In various embodiments, memory can be used, for example, to hold the computer executable instructions and other information useful for converting captured, directed, and reflected light into image data and/or coordinate data. Memory can also be used for holding computer executable instructions for determining coordinate data about objects contacting a surface of a display. In various embodiments, memory 326 can include computer executable instructions to control the light sources, sensors, displays, and other components of the display devices and systems of the present disclosure.

Memory 326 can include various volatile and/or non-volatile memory types. For example, in various embodiments, memory 326 can include volatile and/or non-volatile memory, such as ROM, RAM, and flash memory, for example. Memory can be provided that is magnetic or optically readable, among others.

FIGS. 4A-4C illustrate embodiments of a display device 415 having a display 416 with an angled surface. In various embodiments, the display 416 can be formed from a number of materials such as transparent and semi-transparent that include, but are not limited to, glass, plastic, and a combination of glass and plastic. In addition, the display 416 can be transparent and/or semi-transparent such that a light beam directed within the display 416 can propagate through the display 416 by internal reflection off one or more surfaces of the display 416 and emerge from a surface of the display to form an image thereon.

Displays having angled surfaces can provide for embodiments having narrow form factors. For purposes of illustration, the display device illustrated in FIG. 4A is shown from an angled front view perspective with the display device oriented vertically. The display devices illustrated in FIGS. 4B-4C are shown from a side view perspective with the display device oriented horizontally. The embodiments illustrated in FIGS. 4A-4C are not limited to such orientations. For example, in some embodiments, it might be desirable to position a display device vertically, as for example, when the display device is used as an interactive display by a user of the display in a standing position. In some embodiments, it might be desirable to position the display device horizontally, as for example, where the display device is being used as an interactive display by a user of the display in a sitting position.

FIG. 4A illustrates an embodiment of a display device having a rear angled surface. As shown in FIG. 4A, display device 415 includes a display 416. In various embodiments of the display 416 illustrated in FIG. 4A an image can be formed on a front surface of the display 416. The image can be formed by directing a light beam at an end of the display device such that the light undergoes internal reflection and emerges from a surface of the display 416, when the light beam reaches its critical angle as will be discussed below with respect to FIGS. 4B-4C.

Also illustrated in FIG. 4A is a light source 414. The light source 414 can include any light source for directing a beam of light into a display for forming an image on a surface of the display. For example, in some embodiments, the light source can include light source 214 as discussed above with respect to FIGS. 2A-2B. Thus, in the embodiments illustrated in FIGS. 4A-4C, the light source 414 can include a projector for directing light into the display 416 for providing an image to be displayed on a surface of the display 416.

FIG. 4B illustrates another embodiment of a display device having a rear angled surface. As shown in FIG. 4B, the display device 415 is positioned horizontally. In various embodiments, positioning the display device 415 horizontally can provide for users of the display device to be seated around the display device and/or place objects on a surface and/or touch the surface of the display device.

As shown in FIG. 4B, display device 415 includes display 416. The display 416 includes an expansion region 417 and an angled region 419. The expansion region 417 and the angled region 419 can be integrally formed or can include a seamless interface 421. The seamless interface 421 can provide a boundary at which the expansion region terminates and the angled region initiates. In various embodiments, the expansion region 417 can provide for light that is directed into the display 416 to fan-out before reaching the angled region 419, as will be discussed more fully below.

The expansion region includes a first surface 432, a second surface 434, and an end 436. In various embodiments, the first and second surfaces 432 and 434 can be parallel. The use of parallel surfaces can provide for internal reflection of a light beam as the light beam propagates within the expansion region 417 of the display 416 toward the angled region 419. In addition, parallel surfaces can reflect light beams without changing their angles. In other words, the angle at which a light beam enters the expansion region can remain unchanged as it propagates within the expansion region.

The angled region includes a first surface 418 and a second surface 420. In various embodiments, the second surface can be angled relative to the first surface, such that the display has varying thicknesses. For example, as shown in FIG. 4B, the second surface 420 of the display 416 is angled relative to the first surface 418 such that at the beginning of the angled region, i.e., the seamless interface 421, the display 416 has a first thickness at end 436 and a second thickness at end 438. Angling the second surface 420 relative to the first surface 418 can provide for a beam of light propagating within display 416 to emerge from surface 418 of display 416, and form an image thereon, as will be discussed more fully below.

FIG. 4B also includes a light source. In the embodiment illustrated in FIG. 4B, the light source 414 includes a projector for forming an image on surface 418 of display 416. For example, in the embodiment shown in FIG. 4B, projector 414 directs a beam of light 405 within display 416 through end 436. As the light beam 405 enters the display 416, it fans out in the expansion region 417 and propagates within the expansion region 417 by internal reflection off surfaces 432 and 434 and toward the angled region 419.

As the light beam 405 propagates through the angled region toward the end 438, each time the ray bounces off angled second surface 420, its direction will change with respect to the first surface 418. Repeated reflections will lead to the angle between the light beam and the first surface 418 getting progressively smaller until the ray's critical angle is reached and the ray emerges from the display 416. When a light beam enters the display 416, the larger the angle between the light beam and a surface of the display, the greater the number of reflections that will occur before it emerges. This also means that the light beam can travel further within the angled region before emerging. Thus, the angle at which the light beam 405 enters the display 416 can determine at which position on the first surface 418 of the display 416 the light beam 405 will emerge. By knowing at which position the various light rays within a light beam will emerge from the first surface 418 of display 416, an image can be formed thereon.

In the embodiments described in FIGS. 4A-4C, the light beams that emerge from display 416 are generally, substantially normal to the surface of which they are emerging. In displays, having an angled surface, light beams that emerge from a display surface can leave a portion of the light beam behind. That portion often continues to reflect within the display at least one time. In such cases, the image produced on the surface of the display can be blurred by the image carried in the residual light beam. As such, display device embodiments can include an anti-reflective coating to help reduce the effects of residual beams.

FIG. 4C illustrates another embodiment of a display device having a rear angled surface. The display device illustrated in FIG. 4C includes a display 416 having an expansion region and angled region 417 and 419, respectively. As shown in FIG. 4C, light source 414, i.e., projector, directs a beam of light 405 into end 436 of display 416. The light beam 405 propagates through display 416 and emerges from the display 416 on surface 418 of angled region 419.

Also shown in FIG. 4C is object 408. As discussed above with regard to FIG. 1B, object 408 can include any item, device, component, and/or individual contacting the display. In various embodiments of the present disclosure, users of display device embodiments can interact with a display device by contacting a surface of the display device.

For example, as shown in FIG. 4C, object 408 is a user's finger. As discussed above in FIG. 2B, objects contacting a surface of a display can cause light, propagating within a display, to be disrupted from its reflective path and to scatter. As shown in FIG. 4C, the disruption of the directed light beam 405 is due, in part, to object 408 contacting the first surface 418 of the angled region 419 of display 416.

In various embodiments, an image capture component can be positioned such that it can capture a portion of the directed light as reflected light. That is, in such embodiments, the reflected light beam 411 can include a portion of the directed light beam 405 caused by a disruption of the directed light beam 405 by object 408. In the embodiment shown in FIG. 4C, a portion of the scattered light beam 411 can propagate toward the expansion region 417 and can be captured by a sensor, e.g., image capture component 410.

Information about the position of the object can be determined based upon the scattered light beam 411. For example, computer executable instructions can be used to compare the location of the received scattered light beam 411 with various display location information stored in memory or can be compared to image information either from within the reflected beam 411, within beam 405, or with a data stream provided to light source 414, as discussed above.

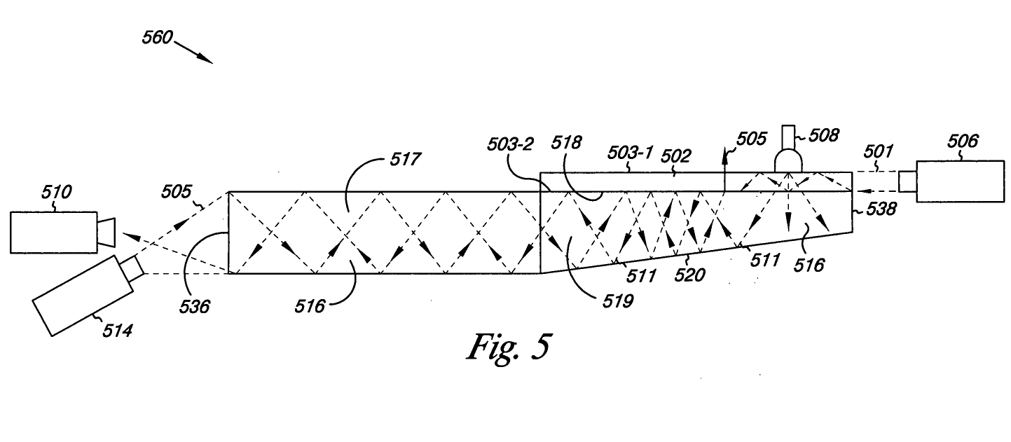

FIG. 5 illustrates an embodiment of a display device having two displays. The displays illustrated in FIG. 5 can include various displays of the embodiments described in FIGS. 1A-1B, 2A-2B, and 4A-4C. For example, in the embodiment shown in FIG. 5, the first display 516 can include a display, such as display 416 illustrated in FIGS. 4A-4C, and the second display 502 can include a display, such as display 102 illustrated in FIGS. 1A-1B.

As shown in FIG. 5, display device 560, includes a first display 516. In the embodiment shown in FIG. 5, the first display 516 includes first and second surfaces 518 and 520 respectively. As discussed above with regard to FIGS. 4A-4C, the second surface 520 can be angled relative to the first surface 518 such that the first end 536 includes a first thickness that is different than a second end 538.

Also shown in FIG. 5 is a first light source 514 for directing a beam of light 505 into display 516. The beam of light 505 propagates by internal reflection within display 516 and emerges from first surface 518 when the beam of light 505 reaches the critical angle to form an image thereon, as discussed above with respect to FIGS. 4A-4C.

Also shown in FIG. 5 is second display 502. Second display 502 includes a first and second surface 503-1 and 503-2. In the embodiment shown in FIG. 5, the first surface 518 of display 516 is contacting the second surface 503-2 of the second display 502. In some embodiments, the first and second displays 516 and 502 respectively, can be positioned such that there is a space between the displays. A second light source 506 can be any light source for directing a beam of light 501 into display 502. For example, second light source 506 can include light source 106 as illustrated above with respect to FIG. 1A. The beam of light 501 can propagate within the second display 502 by internal reflection with substantially no emergence of the light beam from the second display 502.

In the embodiment illustrated in FIG. 5, an object 508 is illustrated. As described above with respect to FIGS. 1B, 2B, and 4C, object 508 can include any item, device, component, and/or individual contacting the display. As shown in FIG. 5, object 508 is illustrated as contacting first surface 503-1 of second display 502. As described above with respect to FIG. 1B, contacting a surface with object 508 can result in a disruption of the internal reflection of light beam 501 as it propagates within display 502. The disruption can cause the light beam 501 to diverge from its reflective path and to scatter. The scattering of the rays of the light beam 501 can cause some of the light rays to reach their critical angle and emerge from second surface 503-2. The scattered light rays 511, that emerge from surface 503-2, enter first surface 518 of the first display 516. As illustrated in FIG. 5, the scattered light rays 511 can propagate within display 516 in one or more directions. As the scattered light rays 511 propagate within display 516, a portion of the scattered light rays travels from the angled region 519 and into the expansion region 517 of display 516.

In various embodiments, a sensor 510 can be positioned at end 536 of display 516. In the embodiment shown in FIG. 5, sensor 510 can include any sensor capable of capturing a light beam. For example, sensor 510 can include sensor 110 as illustrated in FIG. 1B, sensor 210 as illustrated in FIG. 2B or sensor 410 as illustrated in FIGS. 4B and 4C. Positioning sensor 510 at end 536 allows the sensor to capture the scattered light ray 511 as it emerges from end 536. The scattered light rays can be considered to be a reflected light beam. In some embodiments, sensor 510 can also capture a directed light beam, such as residual light returning to the end of the display through internal reflection, for use in comparing the reflected light beam with the directed light beam.

As discussed above with regard to FIG. 3, an image comparator can be used, among other things, for identifying a location of an object contacting one or more surfaces of a display. In the embodiment shown in FIG. 5, an image comparator can be used to identify a position of one or more objects contacting the surface of the second display based upon the differences between a directed light beam and a reflected light beam.

For example, in the embodiment illustrated in FIG. 5, sensor 510 can capture directed light beam 505. For instance, a portion of the light beam can be captured prior to the light beam entering the display or residual light can be captured. As discussed above with respect to FIGS. 2A, 3, and 4A, the directed light beam 505 can include one or more images to be displayed on a surface of a display. Sensor 510 can provide digital data representing the captured directed light beam to an image comparator, such as the image comparator illustrated in FIG. 3. The image comparator can process the digital data representing the directed light beam and compare the digital data with one or images of a reflected light beam, such as scattered light ray 511.

As discussed above, sensor 510 can capture scattered light rays 511 and provide digital data representing the scattered light beam to image comparator. The image comparator can process the data representing the directed and reflected light beams to determine a difference between the directed and reflected light beams. In the embodiment illustrated in FIG. 5, differences between the directed and reflected light beams can include, among other things, a location of an object contacting a surface of the display and/or an interaction between the display device and an object contacting a surface of the display device.

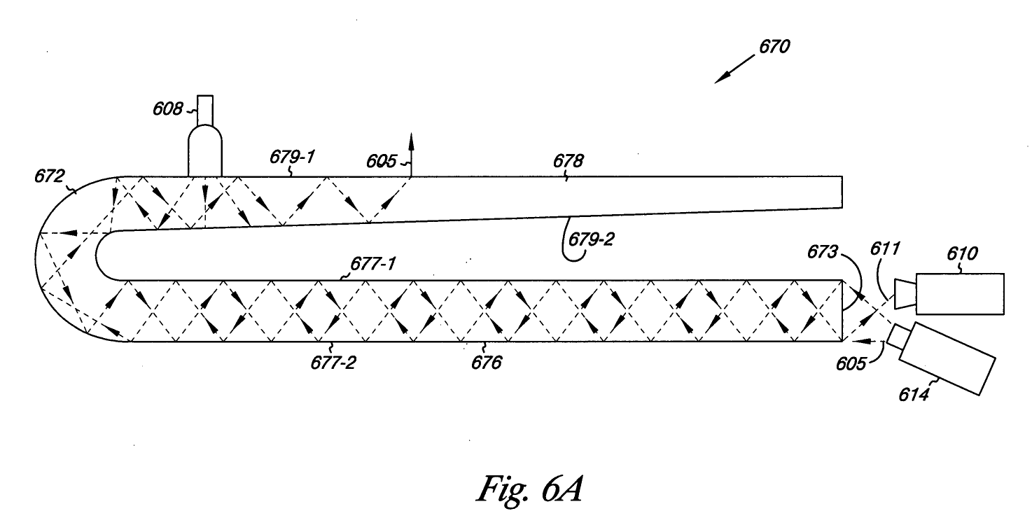

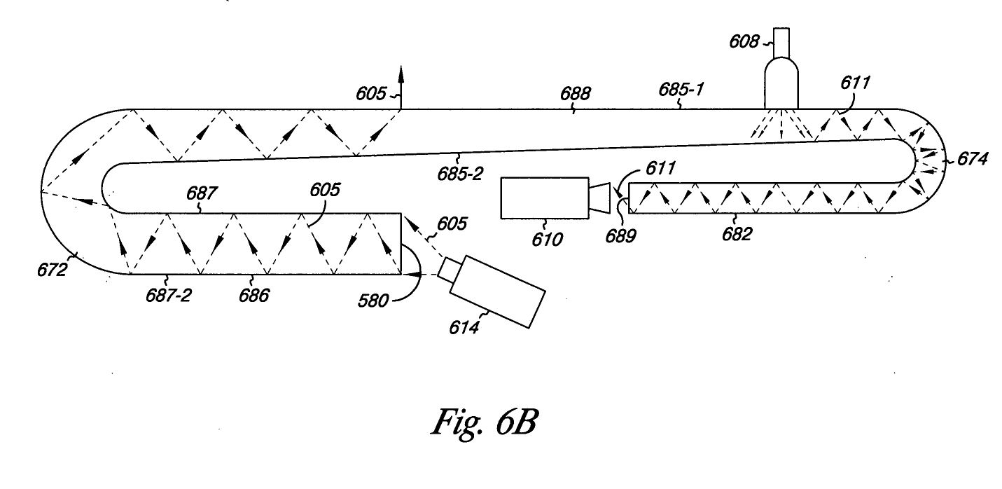

FIGS. 6A-6B illustrate embodiments of a display device having a display with an angled surface and a number of bends. In various embodiments, the display can be formed from a number of materials that include, but are not limited to, glass, plastic, and a combination of glass and plastic. In addition, the display can be transparent and/or semi-transparent such that a light beam directed within the display can propagate through the display by internal reflection off one or more surfaces of the display and emerge from a surface of the display to form an image thereon.

In the embodiments illustrated in FIGS. 6A and 6B, display devices can include one or more displays and/or one or more displays having an expansion region, an angled region, an image capture region, and one or more bends. FIG. 6A illustrates an embodiment of a display device 670 having a bend 672. In the embodiment illustrated in FIG. 6A, display device 670 is illustrated in a horizontal position with an expansion region 676 bent around an angled region 678.

As shown in FIG. 6A, light source 614 directs light beam 605 through end 673 of expansion region 676. As discussed above with respect to FIGS. 4B and 5, the expansion region 676 can provide for the fanning out of the light beam 605 prior to entering the angled region 678. For example, as shown in FIG. 6A, light source 614 emits light beam 605 at end 673 of display 670. As the light beam 605 enters the display 670, it fans out in the expansion region 676 and propagates within the expansion region 676 by internal reflection off surfaces 677-1 and 677-2.

As shown in FIG. 6A, display device 670 includes bend 672. In various embodiments, bend 672 can be used to propagate light beam 605 by internal reflection into the angled region 678.

In the embodiment shown in FIG. 6A, angled region 678 includes first and second surfaces 679-1 and 679-2. As shown in FIG. 6A, second surface 679-2 is angled relative to first surface 679-1. As discussed above with respect to FIGS. 4A-4C and 5, when the light beam enters the angled region, it will act as described with respect to angled region 418 of FIGS. 4B and 4C.

As discussed above with respect to FIGS. 1B, 2B, 3, 4C, and 5, an object contacting a surface of a display can cause a disruption of the reflective path of a light beam and the disruption can be captured by a sensor. In FIG. 6A, object 608 is shown contacting first surface 679-1 of angled region 678. The object contacting the surface can cause a disruption and can scatter light beam 605. A portion of light beam 605 can reflect back as scattered reflected light 611 toward the expansion region 676 and emerge from end 673 where it can be captured by sensor 610, e.g., camera.

The camera 610 can provide data representing the reflected light beam 611 to an image comparator. As discussed above with respect to FIG. 3, the image comparator can execute computer executable instructions for identifying a location of the object 608 on display 670, among other things.

FIG. 6B illustrates an embodiment of a display device having two bends. In the embodiment illustrated in FIG. 6B, display device 680 is illustrated in a horizontal position with an expansion region 686 bent around to an angled region 688. Also shown in FIG. 6B is image capture region 682. In various embodiments, the image capture region 682 can be bent around the angled region 688.

As shown in FIG. 6B, first bend 672 can be used to propagate light beam 605 by internal reflection into angled region 688. As discussed above with respect to FIG. 6A, directed light beam can undergo internal reflection and propagate to angled region 688 to form an image on a surface, i.e., surface 685-1, of the angled region 688 when the rays of the directed light beam 605 reach their critical angle.

Also shown in FIG. 6B is second bend 674. In the embodiment shown in FIG. 6B, a sensor 610 is positioned at end 689. In various embodiments, the second bend can function to guide scattered reflected light from the angled region caused by a disruption by an object contacting the first surface of the angled region. For example, as shown in FIG. 6B, object 608 is shown contacting first surface 685-1 of angled region 688. As discussed above, directed light beam 605 is scattered by object 608. A portion of the scattered light can reflect within the angled region 688 toward the second bend 674 and into the image capture region 682. In various embodiments, a sensor 610 can be positioned near an end 689 of image capture region 682 such that a scattered reflected light beam 611 can be captured by sensor 610, e.g., camera, as it emerges from end 689.

The camera 610 can send data representing the reflected light beam 611 to an image comparator. As discussed above with respect to FIG. 3, the image comparator can execute computer executable instructions for identifying the location of the object 608 on display device 680.

In the embodiments illustrated in FIGS. 6A and 6B, a second display can be provided. In such embodiments, a second light source can also be provided. In various embodiments such as those of FIGS. 6A-6B, a second display can be positioned proximal to the displays 670 and 680 (e.g., on surfaces 679-1 in FIGS. 6A and 685-1 in FIG. 6B. The second display can function similar to the second displays shown and described with respect to FIGS. 2A, 2B, and 5, for example.

In the embodiments described in FIGS. 2A-6B, the identification of a location of an object contacting a surface of a display can include interactions between a display device and/or system and an object. In various embodiments, the interactions between a display device and/or system and an object can include, among other things, gaming, video conferencing, data processing, interactions by an individual with the display device and a user interface provided on a display of the display device, and other such interactions with the display.

Although specific embodiments have been illustrated and described herein, it will be appreciated from this disclosure that any arrangement calculated to achieve the same techniques can be substituted for the specific embodiments shown. This disclosure is intended to cover any and all adaptations or variations of various embodiments of the present disclosure.

It is to be understood that the above description has been made in an illustrative fashion, and not a restrictive one. Combination of the above embodiments, and other embodiments not specifically described herein will be apparent upon reviewing the above description.

The scope of the various embodiments of the present disclosure includes any other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted such that the embodiments of the present disclosure have to include more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A display device, comprising:
a display;
a light source for directing a beam of light into the display such that the beam of light undergoes internal reflection within the display;
an image capture component for capturing one or more images within a reflected beam of light; and
an image comparator for comparing differences between the directed beam of light and the reflected beam of light.

2. The display device of claim 1, wherein the reflected beam of light is a portion of the directed beam of light that has been reflected by an object contacting a surface of the display.

3. The display device of claim 1, further including:
a second display; and
a second light source for directing a beam of light into the second display to form an image on the second display, wherein the reflected light beam is at least a portion of the light beam directed into the second display.

4. The display device of claim 3, wherein the image comparator can identify a position of one or more objects contacting the surface of the display based upon the differences between the directed light beam and the reflected light beam.

5. The display device of claim 1, wherein the light source includes an infrared light source.

6. The display device of claim 1, wherein the image capture component can identify the reflected beam of light when one or more objects contact the surface of the first display.

7. The display device of claim 1, wherein the light source is positioned at an end of the display and the image capture component is positioned at the end.

8. The display device of claim 1, wherein the display includes a wedge shape.

9. The display device of claim 8, wherein the display includes a first bend between the wedge shape and an expansion region.

10. The display device of claim 8, wherein the display includes a second bend, wherein the second bend is between the wedge shape and an image capture region.

11. A display device; comprising:
a display having surfaces arranged to provide internal reflection of a light beam; and
a sensor for capturing a disruption of the internal reflection of the light beam from an object contacting a one of the surfaces of the display.

12. The display device of claim 11, wherein the sensor includes an image capture component.

13. The display device of claim 11, wherein the image capture component includes a camera.

14. The display device of claim 11, wherein the light beam enters the display at one or more ends of the display.

15. The display device of claim 11, wherein the one or more ends of the display include a reflective film.

16. The display device of claim 11, wherein the light source includes an infrared light source.

17. The display device of claim 11, wherein the object includes an object selected from the group including a device, a component, and an individual.

18. The display device of claim 11, wherein the object includes a reflective surface.

19. The display device of claim 11, further including a processor for identifying a location of the object contacting the one or more surfaces of the display based upon capturing the disruption of the internal reflection of the light beam.

20. The display device of claim 11, further including a light source for directing the light beam into the display.

21. The display device of claim 11, wherein the surfaces arranged to provide internal reflection of a light beam are arranged to direct the light beam to form an image on one of the surfaces.

22. A display device, comprising:
a first display;
a second display;
a first light source for directing a beam of light into the first display;
a second light source for directing a beam of light into the second display; and
a sensor for capturing the beam of light from the first light source and a reflected beam of light from the second light source.

23. The display device of claim 22, wherein the second light source is an infrared light source.

24. The display device of claim 22, wherein the first light source forms an image on a surface of the first display by directing the beam of light into the first display.

25. The display device of claim 22, wherein one or more ends of the second display includes a reflective film.

26. The display device of claim 22, wherein the device includes an image comparator for comparing differences between the beam of light from the first light source and the reflected beam of light from the second light source.

27. The display device of claim 26, wherein the image comparator can identify a position of one or more objects contacting a surface of the second display based upon the differences between the first light beam and the second light beam.

28. The display device of claim 26, wherein the image comparator can identify a position of one or more objects contacting the surface of the first display based upon the differences between the first light beam and the second light beam.

29. The display device of claim 22, wherein a surface of the display is constructed such that an object contacting a surface of the display reflects the beam of light from the second light source to form the reflected beam of light.

30. The display device of claim 29, wherein the surface of the display is constructed such that the reflected beam of light has an angle of incidence less than a critical angle and such that the reflected beam of light emerges from the surface of the display.

31. The display device of claim 30, wherein a sensor is positioned to receive the emerged, reflected beam of light.

32. The display device of claim 22, wherein a surface of the first display contacts a surface of the second display.

33. The display device of claim 22, wherein the first light source is positioned at an end of the second display such that light from the first light source is directed into the second display and undergoes internal reflection.

34. The display device of claim 22, wherein the second light source is positioned at a surface of the first display such that light from the second light source is directed toward one of a number of surfaces of the second display to form an image on one of the number of surfaces of the display.

35. A display system, comprising:
a display;
a light source for directing a beam of light into the display such that the beam of light undergoes internal reflection within the display; and
means for capturing a reflected light beam, wherein at least a portion of the directed beam of light becomes the reflected beam of light through an interaction with an object contacting a surface of the display; and
means for comparing data representing the one or more images of the directed light beam with data representing the reflected light beam to determine a difference between the directed light beam data and the reflected light beam data.

36. The display system of claim 35, wherein means for capturing the reflected light beam includes an image capture component.

37. The display system of claim 36, wherein the image capture component is positioned relative to an end of the display.

38. The display system of claim 36, wherein the image capture component is positioned relative to a surface of the display.

39. The display system of claim 35, wherein means for comparing includes identifying a position of one or more objects contacting a surface of the display based upon the differences between the directed light beam and the reflected light beam.

40. The display system of claim 35, wherein means for comparing includes identifying a position of one or more objects contacting a surface of a second display based upon the differences between the directed light beam and the reflected light beam.

41. A display device, comprising:
a first display having a first surface and a second surface, wherein the second surface is angled relative to the first surface;
a second display having a first surface and a second surface, wherein the second surface is parallel to the first surface;
a light source for directing a beam of light into at least one of the displays;
a sensor for capturing the beam of light from a second light source and for capturing a reflected beam of light from the first light source; and
an image comparator for comparing the differences between the beam of light from the second light source and the reflected beam of light from the first light source.

42. The display device of claim 41, wherein the second light source is positioned to direct a light beam into the second display to form an image on the first display.

43. The display device of claim 41, wherein the image comparator can identify a location of an object contacting a surface of the first display based upon the differences between the beam of light from the second light source and the reflected beam of light from the first light source.

44. The display device of claim 41, wherein the object contacting the surface of the first display indicates an interaction between a user and images formed on the first surface of the first display.

45. A display system, comprising:
a display device including:
a display to display one or more user interfaces;
a light source for directing a beam of light into the display such that the beam of light undergoes internal reflection within the display;
a sensor for capturing a reflected beam of light emerging from the display, wherein at least a portion of the directed beam of light becomes the reflected beam of light through an interaction with an object contacting a surface of the display; and
a computing device including:
a processor;
a memory in communication with the processor;
computer executable instructions stored in memory and executable on the processor to:
compare differences between the directed beam of light and the reflected beam of light.

46. The display system of claim 45, wherein the computing device further includes computer executable instructions to calculate differences between the directed beam of light and the reflected beam of light to identify a location of an object contacting one or more surfaces of the display.

47. The display system of claim 46, wherein the computer executable instructions to identify the location of an object further include computer executable instructions to locate an interaction between a display device and an object.

48. The display system of claim 47, wherein computer executable instructions to locate an interaction further include computer executable instruction to locate at least one of a gaming interaction, a video conferencing interaction, a data processing interaction, and an interaction by an individual and the one or more user interfaces provided on the display of the display device.

49. A method, comprising:
directing a beam of light into a display such that the beam of light undergoes internal reflection within the display;
capturing a reflected light beam from a surface of a display, the reflected light beam originating from at least a portion of the directed beam of light disrupted by an object contacting the surface of the display; and
comparing one or more images of a directed light beam with the one or more images of the reflected light beam to determine a difference between the directed light beam and the reflected light beam.

50. The method of claim 49, wherein the beam of light is directed into an end of the display.

51. The method of claim 49, wherein capturing one or more images of the reflected light beam from a surface of the display includes interacting with the surface of the display by contacting the surface of the display.

52. The method of claim 49 further including directing a second beam of light into the display to form one or more images on a surface of the display.

53. The method of claim 52, wherein the second beam of light is directed into an end of the display.

54. The method of claim 52, wherein the second beam of light is directed into the end of the display as the first beam of light.

55. The method of claim 49, further including capturing the one or more images of the directed light beam.

56. The method of claim 55, wherein capturing the one or more images of the directed beam of light occurs at an end of the display.

57. The method of claim 55, wherein capturing the one or more images of the directed beam of light occurs at the same end of the display as the beam of light.

58. The method of claim 55, wherein capturing the one or more images of the directed beam of light occurs at an end of the display as a second beam of light.

59. The method of claim 49, wherein comparing one or more images of a directed light beam with the one or more images of the reflected light beam includes comparing the captured one or more images of the directed light beam with the captured one or more images of the reflected light beam to determine a difference between the captured directed light beam with the captured reflected light beam.

60. The method of claim 49, wherein comparing one or more images of a directed light beam with the one or more images of the reflected light beam indicates a location on the surface of the display of an object contacting the surface of the display.

61. The method of claim 49, wherein comparing one or more images of a directed light beam with the one or more images of the reflected light beam includes using an image subtraction method.

62. A computer readable medium having a set of executable instructions for causing a device to perform a method, comprising:
directing a beam of light into a display such that the beam of light undergoes internal reflection within the display;
capturing a reflected light beam from a surface of a display, the reflected light beam originating from at least a portion of the directed beam of light disrupted by an object contacting the surface of the display; and
comparing one or more images of a directed light beam with the one or more images of the reflected light beam to determine a difference between the directed light beam and the reflected light beam.

63. The medium of claim 62, further including directing light into a display to form one or more images on a surface of the display.

64. The medium of claim 62, further including directing light into a second display, wherein the directed light is emitted from a second light source.

65. The medium of claim 64, further including capturing one or more images of reflected light from a surface of the second display.

66. The medium of claim 62, further including comparing the one or more images of the directed light beam with the captured one or more images of the reflected light beam to determine a difference between the captured directed light beam and the captured reflected light beam.
